(19) United States
(12) Patent Application Publication
(10) Pub. No.: US 2026/0087806 A1
(43) Pub. Date: Mar. 26, 2026

(54) LEARNING DEVICE

(71) Applicant: HONDA MOTOR CO., LTD., Tokyo (JP)

(72) Inventors: Naoki Hosomi, Saitama (JP); Masanori Yoshihira, Saitama (JP); Anirudh Reddy Kondapally, Saitama (JP)

(73) Assignee: HONDA MOTOR CO., LTD., Tokyo (JP)

(21) Appl. No.: 19/107,266

(22) PCT Filed: Sep. 15, 2022
(86) PCT No.: PCT/JP2022/034616

§ 371 Date: Feb. 27, 2025

(51) Int. Cl. G06V 20/40; G06V 10/82; G06V 20/58

(52) U.S. Cl. CPC G06V 20/41; G06V 10/82; G06V 20/58

(57) ABSTRACT

Provided is a system capable of searching for appropriate area around a destination location for a moving body to realize a designated state in accordance with an instruction, by reflecting an instructor's intention underlying the instruction of ambiguous space designation with the destination location as reference. A pre-trained model is built using, as input data, scene graphs SG1 to SG3 created based on a user's instruction and an environment image in a direction toward a location of a moving body 20 and a designated place. The characteristic value of the primary node configuring the state scene graph SG1 is defined depending on the relative arrangement relationship (the distance and the angle) of each object with the location of the moving body 20 as a reference. The characteristic value of the primary node configuring the state scene graph SG1 is defined depending on a space occupancy mode of each object.

### TECHNICAL FIELD

The present invention relates to a learning device that builds a pre-trained model that contributes to realization of a designated state of a target body in a designated space around a designated place.

### BACKGROUND ART

Techniques of generating scene graphs from images are proposed (see, for example, Non Patent Literature 1 and 2). According to the techniques, a step of inputting an image, a step of detecting an object from the image by using an object detection method based on deep learning, a step of detecting a context status in the image by using PLSI, a step of detecting a relation between objects by using a relationship detection and ontology method based on deep learning, and a step of generating a scene graph with respect to the input image are executed.

### CITATION LIST

### Non Patent Literature

Non Patent Literature 1: Learning 3D Semantic Scene Graphs from 3D Indoor Reconstructions, CVPR2020 (https://arxiv.org/pdf/2004.03967v1.pdf) Non Patent Literature 2: Multi-Layer Semantic and Geometric Modeling with Neural Message Passing in 3D Scene Graphs for Hierarchical Mechanical Search, ICRA2020 (https://arxiv.org/pdf/2012.04060.pdf)

### SUMMARY OF INVENTION

### Technical Problem

However, according to technologies in the related art, even when a user instructs a moving body such as a robot “to stop on the right side of ∘∘ (for example, a name of a store, a facility, or the like)”, it is difficult to stop the moving body in an area corresponding to “the right side of ∘∘” intended by the user. This is because, although coordinates of one point are required to stop the moving body, a point is not uniquely expressed by the expression “the right side” contained in the user's instruction. In the first place, the user is not conscious of the expression “the right side” as coordinates of a uniquely determined point, but often refers to a “space” referred to as the right side. Therefore, it is necessary to associate a word contained in the user's instruction with a space. In addition, the space referred to as “the right side” includes a space in which the moving body can stop and a space in which the moving body cannot stop. For example, if “the right side of ∘∘” is an open space, the moving body can stop, and if “the right side of ∘∘” is a crosswalk, the moving body cannot stop.

In this respect, an object of the present invention is to provide a device that generates a pre-trained model capable of searching for an appropriate area around a destination location in order for a target body to realize a designated state in accordance with an instruction, by reflecting an instructor's intention underlying the instruction of ambiguous space designation with the destination location as a reference.

### Solution to Problem

A learning device of the present invention generates a pre-trained model trained on, as learning data,
an instruction to a target body related to realization of a designated state in a designated space around a designated place,
location information of the target body,
a plurality of scene graphs created based on an image around the designated place acquired based on a locational relationship between the target body and the designated place, and
a result of whether or not the designated state of the target body is realizable,
in which the pre-trained model outputs one area candidate from a plurality of area candidates present in a plurality of surrounding spaces with the designated place as a reference.

### BRIEF DESCRIPTION OF DRAWINGS

FIG. 1 is an illustrative diagram regarding configurations of a learning device and a moving body assistance device.

FIG. 2 is an illustrative diagram regarding a pre-trained model generating function.

FIG. 3 is an illustrative diagram regarding an image including a plurality of objects.

FIG. 4 is an illustrative diagram regarding a result of projecting a three-dimensional high-definition map onto a two-dimensional map.

FIG. 5 is an illustrative diagram of a state scene graph.

FIG. 6 is an illustrative diagram of a layout scene graph.

FIG. 7 is an illustrative diagram of an instruction scene graph.

FIG. 8 is a conceptual illustrative diagram of sequential convolution and pooling of scene graphs.

FIG. 9 is an illustrative diagram regarding a graph neural network.

FIG. 10 is a conceptual illustrative diagram of sequential convolution and pooling of scene graphs input to the graph neural network.

FIG. 11 is an illustrative diagram regarding correct data in different traveling scenes.

FIG. 12 is an illustrative diagram regarding correct data in traveling scenes in which presence modes of obstacles are different.

FIG. 13 is an illustrative diagram regarding an area candidate output function of a moving body assistance system.

### DESCRIPTION OF EMBODIMENTS

### (Configuration)

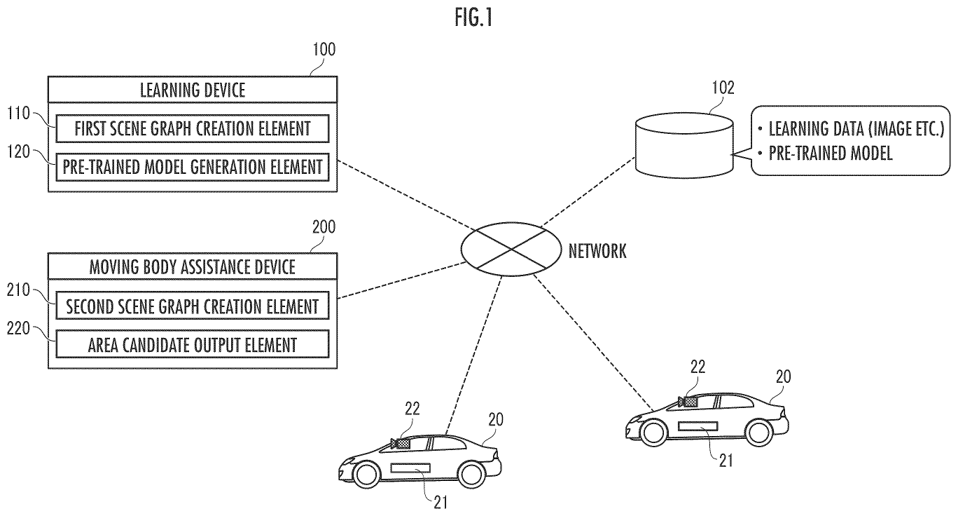

Each of a learning device 100 and a moving body assistance device 200 as an embodiment of the present invention illustrated in FIG. 1 is configured as a device capable of accessing a database 102 via a network in order to assist realization of a designated state of a moving body 20 (corresponding to a “target body” of the present invention). The moving body 20 and the moving body assistance device 200 constitute a “moving body system”.

The database 102 stores and holds an environment image (corresponding to an “image” of the present invention) showing a state around the moving body 20, a three-dimensional high definition map (map information), a graph neural network, a pre-trained model, and the like. In the present embodiment, the database 102 is configured of a device or a database server separate from the learning device 100 and the moving body assistance device 200, and may be a component of the learning device 100 and/or the moving body assistance device 200.

The learning device 100 includes a first scene graph creation element 110 and a pre-trained model generation element 120. Each of the first scene graph creation element 110 and the pre-trained model generation element 120 includes an arithmetic processing element such as a CPU and/or a processor core, a storage element such as a ROM and/or a RAM, an input/output interface circuit, and the like. Each of the first scene graph creation element 110 and the pre-trained model generation element 120 is configured to execute a designated task, such as each of scene graph creation and pre-trained model generation to be described below. That a functional element is configured to execute the designated task means that hardware constituting the functional element reads software and data as necessary from the storage element, and executes the designated task by executing arithmetic processing of the data or other data as target data according to the software.

The moving body assistance device 200 includes a second scene graph creation element 210 and an area candidate output element 220. Each of the second scene graph creation element 210 and the area candidate output element 220 includes an arithmetic processing element such as a CPU and/or a processor core, a storage element such as a ROM and/or a RAM, an input/output interface circuit, and the like. Each of the second scene graph creation element 210 and the area candidate output element 220 is configured to execute a designated task such as each of scene graph creation and pre-trained model generation to be described below.

The learning device 100 and the moving body assistance device 200 may be configured of the same device. In this case, both the first scene graph creation element 110 and the second scene graph creation element 210 may be configured of a single scene graph creation element.

The moving body 20 is configured of a vehicle or a robot having an autonomous movement function, a positioning function, and a wireless communication function. The moving body 20 includes a moving body control device 21 and an imaging device 22. The moving body 20 may include an information processing terminal (for example, a smartphone) that is carried by a user and is passively moved with the movement of the user. The moving body assistance device 200 may be configured of a device (for example, the moving body control device 21) mounted on the moving body 20.

The moving body control device 21 includes an arithmetic processing element such as a CPU and/or a processor core, a storage element such as a ROM and/or a RAM, an input/output interface circuit, and the like. The moving body control device 21 is configured to control an autonomous movement function, a positioning function, and a wireless communication function of the moving body 20. The imaging device 22 is mounted on the moving body 20 to image a state in a traveling direction or in front of the moving body 20. The moving body 20 may have a function of adjusting an imaging direction (optical axis direction) of the imaging device 22 and/or a function of measuring the imaging direction.

### (Pre-Trained Model Generating Function)

By the pre-trained model generating function, a pre-trained model is generated on the basis of an instruction (corresponding to a “learning instruction”) related to a designated state of the moving body 20 (corresponding to a “moving body for learning”) in a designated space around a designated place and an environment image (corresponding to a “learning environment image”) showing the designated place and a state around the designated place acquired in a direction toward a location of the moving body 20 and the designated place.

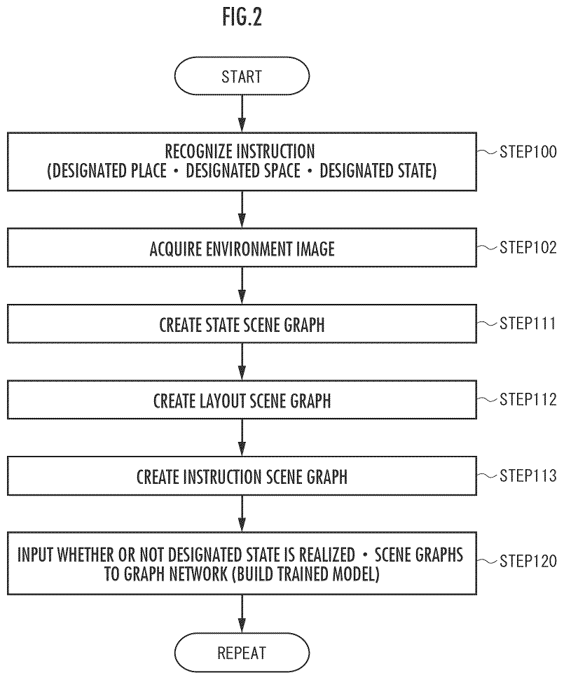

Specifically, an instruction from the user to the moving body 20 through an input interface of a device owned by the user is transmitted from the device to the learning device 100, and is recognized by the first scene graph creation element 110 (FIG. 2/STEP 100). The environment image may be stored and held in the database 102, or may be directly transmitted from the device to the learning device 100.

The “instruction” is an instruction related to a designated state of the moving body 20 in a designated space around a designated place. This means that, for example, an instruction of “please stop on the right side of X” is recognized as an instruction related to realization of a stopped state as a designated state of the moving body 20 in a space on a right side as a designated space around a designated place represented by the word X. In addition, an instruction of “please decelerate before Y” is recognized as an instruction related to realization of a state of starting deceleration as a designated state of the moving body 20 in a space on a front side as a designated space around a designated place represented by the word Y. Further, an instruction of “please pass the left side of Z” is recognized as an instruction related to realization of a passing state as a designated state of the moving body 20 in a space on a left side as a designated space around a designated place represented by the word Z.

The user who makes an instruction may be the user in a place different from the moving body 20 in addition to the user boarding the moving body 20. The user's instruction may be a voice instruction or a gesture instruction.

The imaging device 22 mounted on the moving body 20 acquires an environment image showing a designated place and a surrounding state acquired in a direction toward the location of the moving body 20 and the designated place (an imaging direction of the imaging device 22) (FIG. 2/STEP 102). The environment image may be stored and held in the database 102, or may be directly transmitted from the moving body 20 to the learning device 100.

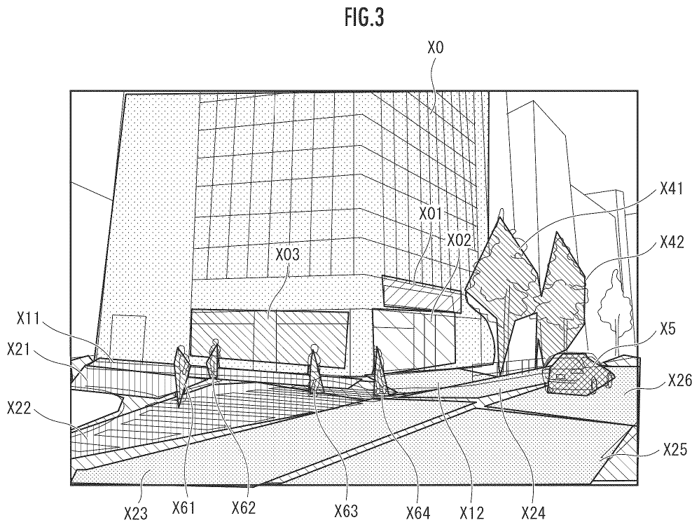

This causes acquisition of, for example, as illustrated in FIG. 3, an environment image including a building structure X₀ (building), sidewalk grid cells X₁₁ and X₁₂ extending along lower end edges of two side surfaces of the building structure X₀, roadway grid cells X₂₁ to X₂₆ expanding outward from the sidewalk grid cells X₁₁ and X₁₂ as viewed from the building structure X₀, and trees X₄₁ and X₄₂ standing on a boundary between the sidewalk grid cell X₁₂ and the roadway grid cell X₂₄. One side surface of the building structure X₀ has a store sign X₀₁ and a window X₀₂, and the other side surface has a window X₀₃. The environment image illustrated in FIG. 3 further includes a vehicle X₅ and pedestrians X₆₁ to X₆₄ as traffic participants.

A state scene graph SG1 is created by the first scene graph creation element 110 on the basis of a location of the moving body 20 (at the time when the environment image is acquired), the environment image, and the map information (FIG. 2/STEP 111).

The map information is, for example, a three-dimensional high-definition map, and includes static information such as a three-dimensional structure, road surface information, and lane information. Here, types and/or attributes of objects or things are defined to be distinguished with labels. For example, an object having a certain height or more from a ground surface and an object expanding along a terrain are distinguished with respective labels. The label is defined by a label area (an area occupied by a labeled object in the environment image) and a label ID.

The “object having a certain height or more from a ground surface” which is a first rank object is classified into, for example, a second rank object such as a building structure, a columnar structure, and a tree. The “building structure” which is the second rank object is classified into, for example, a third rank object such as a side wall, a store sign, a window, and an entrance for a person or a vehicle. The “columnar structure” which is the second rank object is classified into, for example, a third rank object such as a traffic signal pole, a traffic sign pole, and a communication equipment pole. From the third rank object, the objects may be further finely classified.

The “object expanding along the terrain” which is the first rank object is classified into, for example, a second rank object such as a roadway and a sidewalk. The “roadway” which is the second rank object is divided as the third rank object into a plurality of roadway grid cells, and each roadway grid cell is defined as an individual object. The “roadway grid cell” which is the third rank object is classified into a fourth rank object such as a road sign such as a crosswalk, a center line, a lane boundary line, and a zebra zone. The “sidewalk” which is the second rank object is divided into, for example, a plurality of sidewalk grid cells, and each sidewalk grid cell is defined as an individual object. The “sidewalk grid cell” which is the third rank object is classified into the fourth rank object including a road sign such as a braille block. From the fourth rank object, the objects may be further finely classified.

A label defined in the three-dimensional high-definition map is assigned to each of the objects imaged in the environment image. A label is also assigned to an object corresponding to dynamic information, such as a vehicle present on a roadway, a pedestrian present on a sidewalk or a roadway (crosswalk). In the state scene graph SG1, each object (or a label thereof) to which a label is assigned is defined as a primary node.

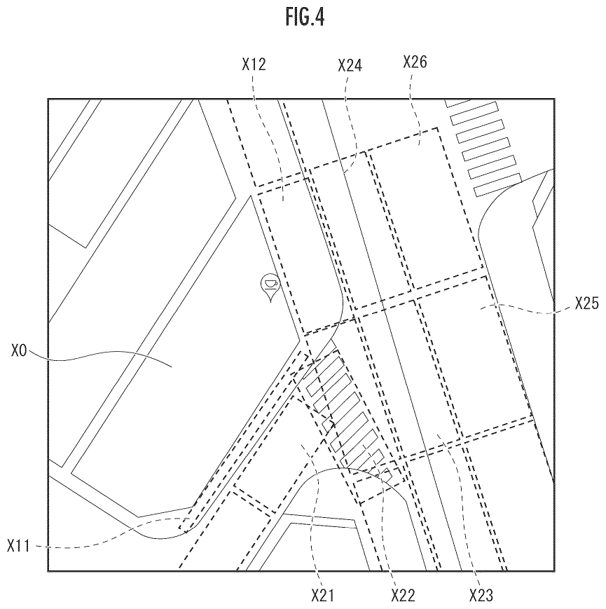

FIG. 4 illustrates a result of projecting static objects (a building structure, a sidewalk grid cell, and a roadway grid cell) of a three-dimensional high definition map as a two-dimensional map. The two-dimensional map illustrated in FIG. 4 includes the building structure X₀ (building), the sidewalk grid cells X₁₁ and X₁₂ extending along lower end edges of two side surfaces of the building structure X₀, and the roadway grid cells X₂₁ to X₂₆ as static objects among the objects included in the environment image illustrated in FIG. 3. By using the two-dimensional map, recognition accuracy of adjacency relationships between the objects and relative arrangement relationships of the objects with the moving body 20 as a reference is improved.

In the state scene graph SG1, an adjacency relationship between the objects is defined as an edge. The adjacency relationship of the objects indicates a direction (for example, a front, rear, left, or right direction) in which another object adjacent to one object is present with the one object as a reference.

A characteristic value of the primary node is defined depending on a relative arrangement relationship between an object and the moving body 20 and a space occupancy mode of the object. The relative arrangement relationship between the object and the moving body 20 is defined by a center or a center of gravity of the object (or a label), a relative distance between the moving body 20 (or the imaging device 22) and the object, and an angle of orientation of a direction in which the object is present with a traveling direction of the moving body 20 or an orientation depending on a posture of the moving body 20 as a reference.

In a case where an environment image (for example, a distance measurement image having a distance from the imaging device 22 as a pixel value) including information for enabling the primary node and a characteristic value thereof to be identified is obtained, the three-dimensional high-definition map may not be used.

The space occupancy mode of the object is defined by, for example, an occupancy flag (0 . . . Unoccupied, 1 . . . Occupied) indicating whether or not a static object (a building structure, a columnar structure, a tree, or the like) occupies an area in a form that does not allow passage of the moving body 20 (whether or not the static object corresponds to an object having a certain height or more from the ground). Further, the space occupancy mode of the object is defined by an interference flag (0 . . . Nonpresent, 1 . . . Present) indicating whether or not a dynamic object (a vehicle, a pedestrian, or the like) as a designated object is present in an area in a form that is capable of interfering with the moving body 20.

For example, in a case where an object corresponding to the primary node is a “road grid cell” and another vehicle or the like is present in the road grid cell, the moving body 20 can pass through an area corresponding to the object but may interfere with the another vehicle or the like. Hence, the occupancy flag is defined as “0”, but the interference flag is defined as “1”. However, regarding the roadway grid cell in which stopping is not allowed in view of a road sign (example: Crosswalk or No Parking), “1” is defined or assigned as the occupancy flag in a case where the designated state of the moving body 20 corresponds to a stopped state. The characteristic value of the primary node may be further defined by a “label area” and a “label ID”.

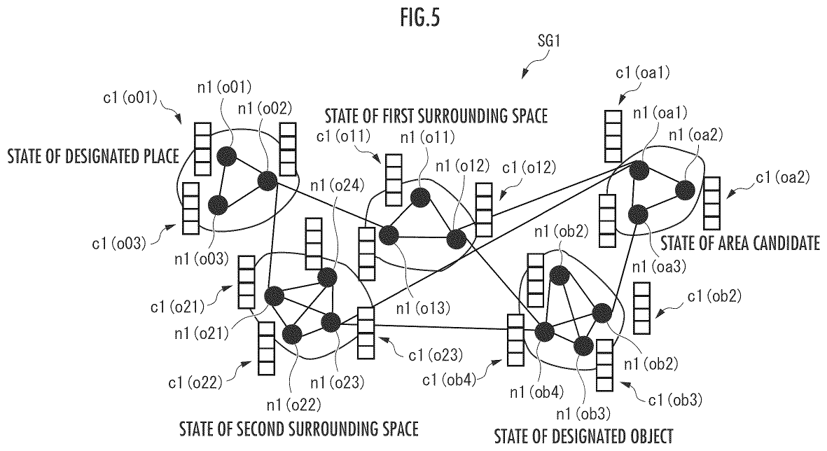

As schematically illustrated in FIG. 5, in the state scene graph SG1, a plurality of primary nodes n₁₍ₓ₎ (x represents each object or a label thereof) having respective characteristic values c1(x) are associated with edges. The scene graph SG1 illustrated in FIG. 5 includes objects o₀₁, o₀₂, and o₀₃ representing respective states of a designated place (an example: a designated store or a building including the designated store), objects o₁₁, o₁₂, and o₁₃ representing respective states of a first surrounding space (an example: a space on the south side of the building) with the designated place as a reference, objects o₂₁, o₂₂, o₂₃, and o₂₄ representing respective states of the first surrounding space (an example: a space on the east side of the building) with the designated place as a reference, objects oₐ₁, oₐ₂, and oₐ₃ representing respective states of an area candidate (an example: the road grid cell), and objects o_{b1}, o_{b2}, o_{b3}, and o_{b4} representing respective states of the designated object (an example: a traffic participant).

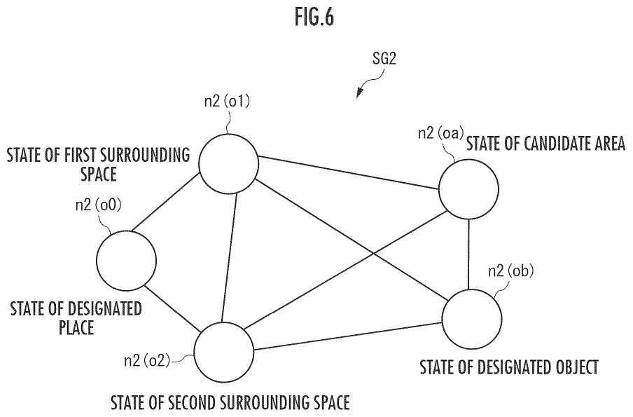

Subsequently, a layout scene graph SG2 is created by convolving and pooling the state scene graphs SG1 by the first scene graph creation element 110 (FIG. 2/STEP 112). This means that, for example, the layout scene graph SG2 schematically illustrated in FIG. 6 is created as a result of convolving the state scene graphs SG1 schematically illustrated in FIG. 5. The granularity of the layout scene graph SG2 is lower than the granularity of the unconvolved state scene graphs SG1.

Each of secondary nodes n₂₍ₒ₀₎, n₂₍ₒ₁₎, n₂₍ₒ₂₎, n₂₍ₒₐ₎, and n_{2(ob)} defining the layout scene graph SG2 illustrated in FIG. 6 represents each of primary node clusters corresponding to each of the “designated place”, the “first surrounding space”, and the “second surrounding space”, an “area candidate in a plurality of surrounding spaces”, and a “designated object”. For example, the primary node cluster corresponding to the designated place includes primary nodes n₁₍ₒ₀₁₎, n₁₍ₒ₀₂₎, and n₁₍ₒ₀₃₎ representing respective states of the designated place (fan example: a designated store or a building including the designated store) in the state scene graph SG1 illustrated in FIG. 5. An edge defining the layout scene graph SG2 illustrated in FIG. 6 represents an adjacency relationship between object clusters corresponding to the primary node clusters represented by the individual secondary nodes n₂₍ₒ₀₎, n₂₍ₒ₁₎, n₂₍ₒ₂₎, n₂₍ₒₐ₎, and n_{2(ob)}. For example, an edge between the secondary node n₂₍ₒ₀₎ corresponding to the “designated place” and n₂₍ₒ₂₎ corresponding to the “second surrounding space” indicates that the second surrounding space is present on the east side of the designated place. Each of the secondary nodes n₂₍ₒ₀₎, n₂₍ₒ₁₎, n₂₍ₒ₂₎, n₂₍ₒₐ₎, and n_{2(ob)} has a characteristic value determined depending on the characteristic value of the primary node cluster which becomes a convolution target (as a result of aggregating the characteristic values of the primary node clusters).

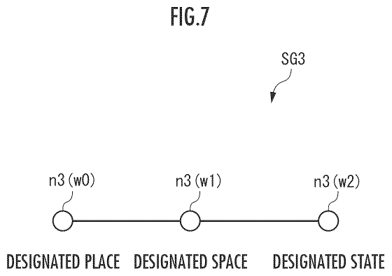

Further, an instruction scene graph SG3 is created by convolving and pooling the layout scene graphs SG2 by the first scene graph creation element 110 (FIG. 2/STEP 113). This means that, for example, the instruction scene graph SG3 schematically illustrated in FIG. 7 is created as a result of convolving the layout scene graphs SG2 schematically illustrated in FIG. 6. The granularity of the instruction scene graph SG3 is lower than the granularity of the unconvolved layout scene graph SG2.

Each of tertiary nodes n_{3(w0)}, n_{3(w1)}, and n_{3(w2)} defining the instruction scene graph SG3 illustrated in FIG. 7 represents a secondary node cluster corresponding to a word related to each of the “designated place”, the “designated space”, and the “designated state” included in the user's instruction. For example, the secondary node cluster corresponding to the designated space includes the secondary nodes n₂₍ₒ₁₎ and n₂₍ₒ₂₎ representing states of the first surrounding space and the second surrounding space in the layout scene graph SG2 illustrated in FIG. 6 and secondary nodes associated with these nodes by edges. An edge defining the instruction scene graph SG3 illustrated in FIG. 7 represents an adjacency relationship between words. Each of the tertiary nodes n_{3(w0)}, n_{3(w1)}, and n_{3(w2)} has a characteristic value determined depending on the characteristic value of the secondary node cluster which becomes a convolution target.

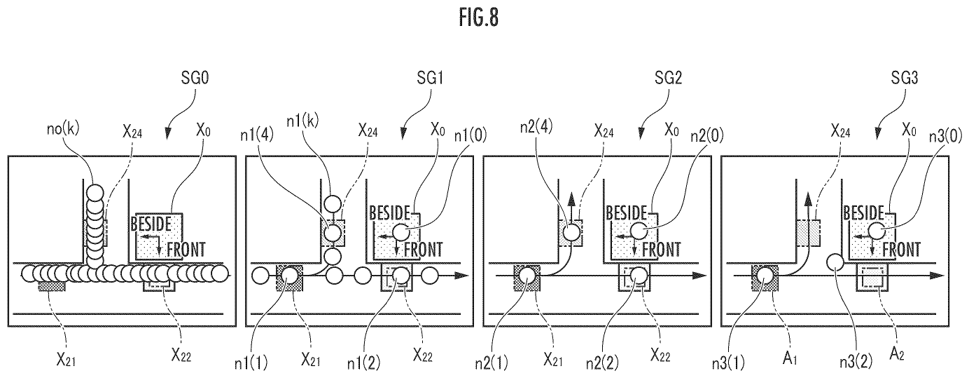

FIG. 8 conceptually illustrates a procedure in which the state scene graph SG1 (the primary scene graph) is generated by convolving and pooling initial scene graphs SG0, the layout scene graph SG2 (the secondary scene graph) is generated by convolving and pooling the state scene graphs SG1, and the instruction scene graph SG3 (the tertiary scene graph) is generated by convolving and pooling the layout scene graphs SG2. For example, general-purpose “Aggregate”, “Update”, or “Readout” is employed as a convolution technique, and “average pooling” is employed as a pooling technique.

Each of the scene graphs SG0, SG1, SG2, and SG2 illustrated in FIG. 8 includes the building structure X₀ as a destination or a designated place bordering a three-forked road (or a T-junction), and parking spaces X₂₁, X₂₂, and X₂₄ (as road grid cells) on the three-forked road. As illustrated in FIG. 8, the parking space X₂₂ is present in front of the building structure X₀ (a lower direction in FIG. 8), the parking space X₂₄ is present beside the building structure X₀ (a left direction in FIG. 8), and the parking space X₂₁ is present on a road which does not border the building structure X₀. In this scene, an obstacle is present in the parking space X₂₁.

The initial scene graph SG0 illustrated in FIG. 8 includes a plurality of initial nodes n₀₍ₖ₎ arranged along a lane on which a vehicle approaching a three-forked road from the left side can travel. The building structure X₀ as a goal is regarded as a node. Location information obtained by discretizing route information described on a three-dimensional map (high-resolution map) at unequal intervals is set as a node. A grid cell having a predetermined size defined around a node has attributes of occupied/unoccupied/no parking. The attributes of the grid cell are regarded as no parking in places such as crosswalks, within an intersection, and/or no road parking.

The state scene graph SG1 illustrated in FIG. 8 includes, in addition to a primary node n₀₍₁₎ corresponding to the building structure X₀, a plurality of primary nodes n₁₍ₖ₎ arranged more sparsely than the plurality of initial nodes n₀₍ₖ₎ as a result of convolution and pooling of the plurality of initial nodes n₀₍ₖ₎ corresponding to the road grid cell. The plurality of primary nodes n₁₍ₖ₎ include primary nodes n₁₍₁₎, n₁₍₂₎, and n₁₍₄₎ respectively corresponding to parking spaces X₂₁, X₂₂, and X₂₄, respectively, on the three-forked road.

The layout scene graph SG2 illustrated in FIG. 8 includes, in addition to the secondary node n₀₍₂₎ corresponding to the building structure X₀, secondary nodes n₂₍₁₎, n₂₍₂₎, and n₂₍₄₎ corresponding to the parking spaces X₂₁, X₂₂, and X₂₄, respectively, on the three-forked road as a result of convolution and pooling of the plurality of primary nodes n₁₍ₖ₎ corresponding to the road grid cells. That is, each of the secondary nodes n₂₍₁₎, n₂₍₂₎, and n₂₍₄₎ is a result of convolution and pooling of the plurality of primary nodes n₁₍ₖ₎ present in and near the respective parking spaces X₂₁, X₂₂, and X₂₄ on each of three roads constituting the three-forked road.

The instruction scene graph SG3 illustrated in FIG. 8 includes, in addition to a tertiary node n₃₍₀₎ corresponding to the building structure X₀, a tertiary node n₃₍₁₎ that is the same as the secondary node n₂₍₁₎ corresponding to the parking space X₂₁ in which an obstacle is present, of the parking spaces X₂₁, X₂₂, and X₂₄, and a tertiary node n₃₍₂₎ as a result of convolution and pooling of the secondary nodes n₂₍₂₎ and n₂₍₄₎ corresponding to the respective parking spaces X₂₂ and X₂₄ in which no obstacle is present.

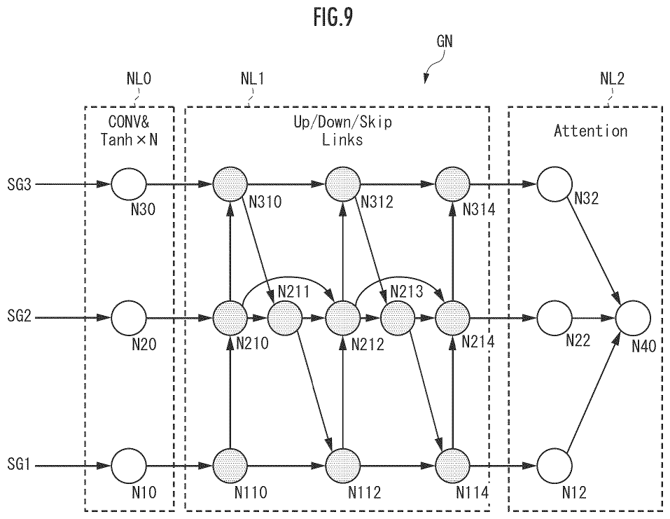

Next, the pre-trained model generation element 120 inputs, as input data, the state scene graph SG1, the layout scene graph SG2, and the instruction scene graph SG3 together with an area in which the designated state of the moving body 20 is realized to a graph neural network GNN, thereby generating or building a pre-trained model (FIG. 2/STEP 120). For example, as illustrated in FIG. 9, the graph neural network GNN includes an input layer NL0, an intermediate layer NL1, and an output layer NL2. A model is built by adjusting a value of a parameter such as a weight coefficient of each node constituting the graph neural network GNN such that one area candidate output from the graph neural network GNN matches a correct area indicated by input data.

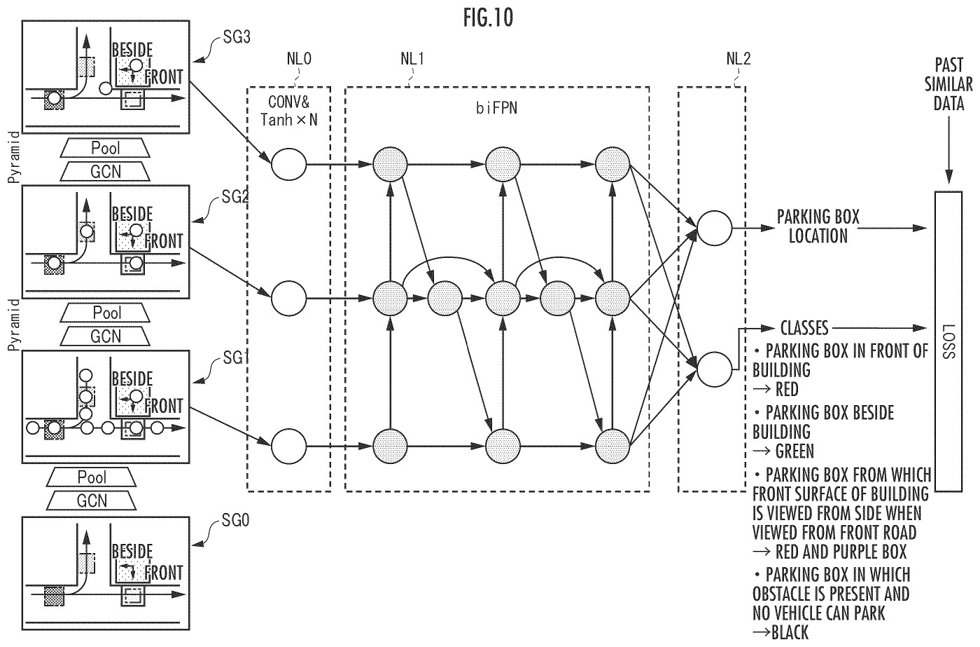

FIG. 10 conceptually illustrates a procedure in which the state scene graph SG1 (the primary scene graph) is generated by convolving and pooling initial scene graphs SG0, the layout scene graph SG2 (the secondary scene graph) is generated by convolving and pooling the state scene graphs SG1, and the instruction scene graph SG3 (the tertiary scene graph) is generated by convolving and pooling the layout scene graphs SG2. In FIG. 10, “GCN” represents convolution processing by a graph convolution neural network, and “Pool” represents pooling processing.

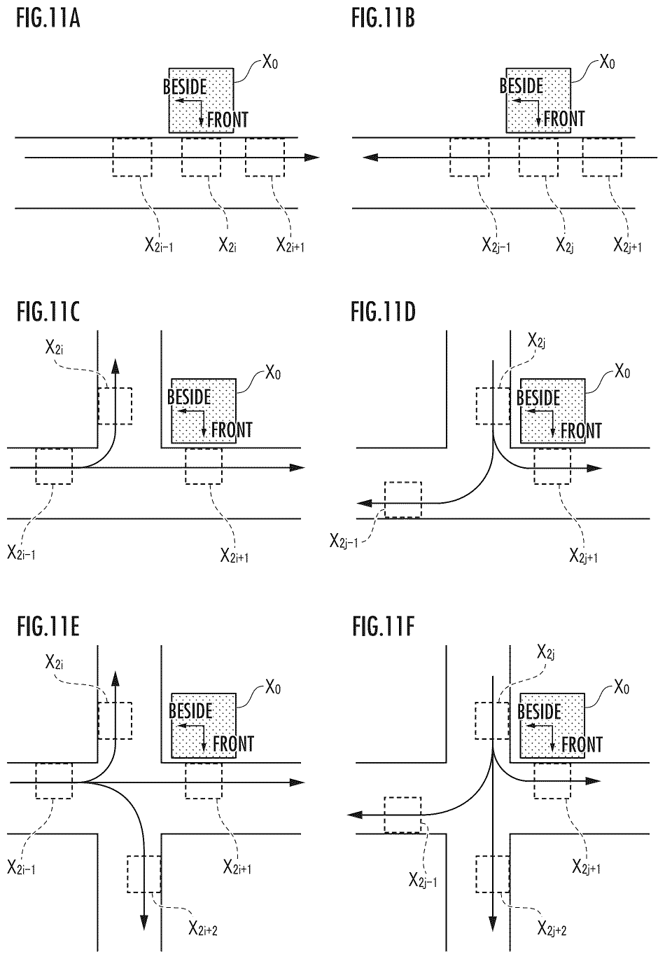

FIG. 11 illustrates correct data in each of different traveling scenes of a vehicle. As illustrated in FIG. 11(1), a traveling scene in which a vehicle approaches the building structure X₀ bordering a road from the left side of the drawing along the road extending in a left-right direction will be described. In this traveling scene, for example, in response to instructions of “stopping in front of the building structure X₀”, “stopping beside the building structure X₀”, and “stopping on a corner of the building structure X₀”, it is defined as a correct answer to park the vehicle in any one of parking spaces X₂ᵢ₋₁, X₂ᵢ, and X₂ᵢ₊₁ in front of the building structure X₀ (the lower direction in the drawing). on a lane of the road on which the vehicle can travel.

As illustrated in FIG. 11(2), a traveling scene in which a vehicle approaches the building structure X₀ bordering a road from the right side of the drawing along the road extending in the left-right direction will be described. In this traveling scene, in response to a similar instruction, it is defined as a correct answer to park the vehicle in any one of parking spaces X₂ⱼ₋₁, X₂ⱼ, and X₂ⱼ₊₁ in front of the building structure X₀ on a lane of the road on which the vehicle can travel (a lane opposite to that in FIG. 11(1)).

As illustrated in FIG. 11(3), a traveling scene in which the vehicle approaches the building structure X₀ bordering the three-forked road from the left side of the drawing will be described. In this traveling scene, for example, in response to instructions of “stopping in front of the building structure X₀”, “stopping beside the building structure X₀”, and “stopping on a corner of the building structure X₀”, it is defined as a correct answer to park the vehicle in each of the parking space X₂ᵢ₊₁ in front of the building structure X₀ (the lower direction in the drawing), the parking space X₂ᵢ beside the building structure X₀ (the left direction in the drawing), and the parking space X₂ᵢ₋₁ slightly separated from the building structure X₀, on a lane of the three-forked road on which the vehicle can travel.

As illustrated in FIG. 11(4), a traveling scene in which the vehicle approaches the building structure X₀ bordering the three-forked road from the upper side of the drawing will be described. In this traveling scene, for example, in response to instructions of “stopping in front of the building structure X₀”, “stopping beside the building structure X₀”, and “stopping on a corner of the building structure X₀”, it is defined as a correct answer to park the vehicle in each of the parking space X₂ⱼ beside the building structure X₀ (the left direction in the drawing), the parking space X₂ⱼ₊₁ in front of the building structure X₀ (the lower direction in the drawing), and the parking space X₂ⱼ₋₁ slightly separated from the building structure X₀, on a lane of the three-forked road on which the vehicle can travel.

As illustrated in FIG. 11(5), a traveling scene in which the vehicle approaches the building structure X₀ bordering a crossroad from the left side of the drawing will be described. In this traveling scene, for example, in response to instructions of “stopping in front of the building structure X₀”, “stopping beside the building structure X₀”, and “stopping on a corner of the building structure X₀”, it is defined as a correct answer to park the vehicle in each of the parking space X₂ᵢ₊₁ in front of the building structure X₀ (the lower direction in the drawing), the parking space X₂ᵢ beside the building structure X₀ (the left direction in the drawing), and the parking space X₂ᵢ₋₁ or X₂ᵢ₋₂ slightly separated from the building structure X₀, on a lane of the crossroad on which the vehicle can travel.

As illustrated in FIG. 11(6), a traveling scene in which the vehicle approaches the building structure X₀ bordering a crossroad from the upper side of the drawing will be described. In this traveling scene, for example, in response to instructions of “stopping in front of the building structure X₀”, “stopping beside the building structure X₀”, and “stopping on a corner of the building structure X₀”, it is defined as a correct answer to park the vehicle in each of the parking space X₂ⱼ beside the building structure X₀ (the left direction in the drawing), the parking space X₂ⱼ₊₁ in front of the building structure X₀ (the lower direction in the drawing), and the parking space X₂ⱼ₋₁ or X₂ⱼ₊₂ slightly separated from the building structure X₀, on a lane of the crossroad on which the vehicle can travel.

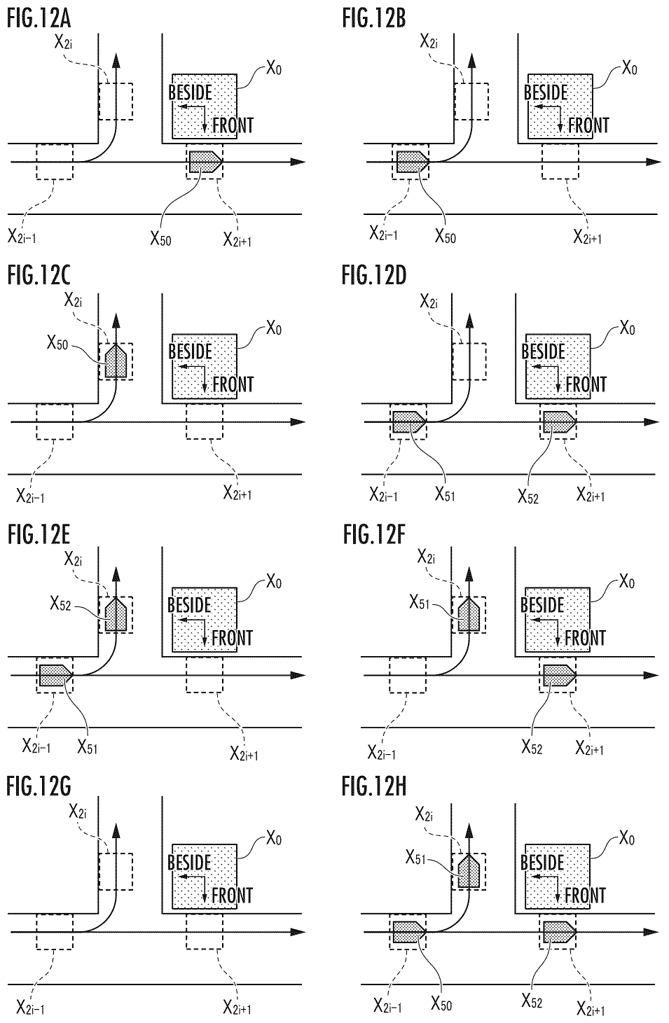

As illustrated in FIG. 11(3), FIG. 12 illustrates correct data in a traveling scene in which the vehicle approaches the building structure X₀ bordering the three-forked road from the left side of the drawing. As illustrated in each of FIGS. 12(1) to 12(3), of the parking spaces X₂ᵢ₋₁, X₂ᵢ, and X₂ᵢ₊₁, it is defined as a correct answer to park the vehicle in any one of the two parking spaces in which an obstacle X₅₀ is not present. As illustrated in each of FIGS. 12(4) to 12(6), of the parking spaces X₂ᵢ₋₁, X₂ᵢ, and X₂ᵢ₊₁, it is defined as a correct answer to park the vehicle in the one parking space in which any obstacles X₅₁ and X₅₂ are not present. As illustrated in FIG. 12(7), it is defined as a correct answer to park the vehicle in any one of the parking spaces X₂ᵢ₋₁, X₂ᵢ, and X₂ᵢ₊₁ in which no obstacle is present. As illustrated in each of FIG. 12(8), it is defined as a correct answer to park the vehicle in none of the parking spaces X₂ᵢ₋₁, X₂ᵢ, and X₂ᵢ₊₁ in which the obstacles X₅₀, X₅₁, and X₅₂ are present, respectively.

At each of nodes N30, N20, and N10 constituting the input layer NL0, the characteristic values of the primary, secondary, and tertiary nodes constituting the three scene graphs SG1 to SG3, respectively, are vectorized.

In the intermediate layer NL1, the weight coefficient is propagated from bottom to top between nodes (nodes N110→N210→N310, nodes N112→N212→N312, nodes N114→N214→N314), and subsequently, the weight coefficient is propagated from top to bottom between nodes (nodes N310→N211→N112, nodes N312→N213→N114). In the intermediate layer NL1, the weight coefficient is propagated in an order of the nodes N210, N212, and N214 by skipping the intermediate nodes N211 and N213.

The output layer NL2 includes three nodes N32, N22, and N12 from which primary determination results corresponding to the three respective scene graphs SG1 to SG3 are output, and a node N40 from which one area candidate is output as a secondary determination result by integrating the primary results. A graph tension network (GAN) may be employed as the graph neural network GNN. In this case, for example, by introducing attention, a score of importance (weight coefficient) is assigned to a relationship between the three nodes N32, N22, and N12, and an output result is flexibly changed.

### (Area Candidate Output Function)

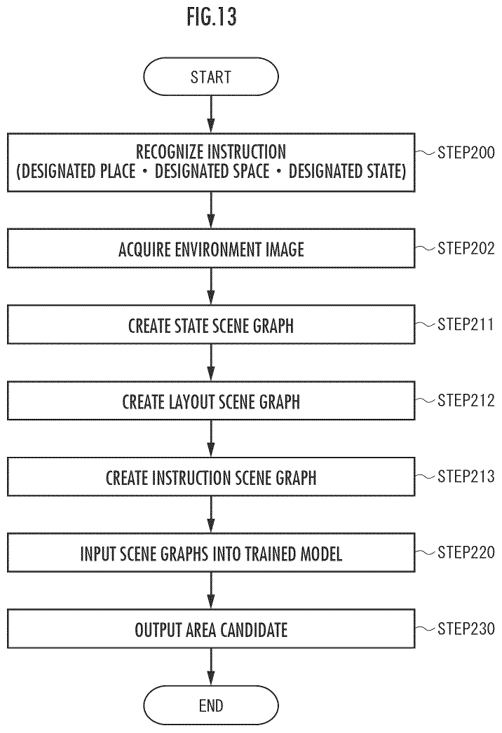

After the pre-trained model is generated or built as described above, one area candidate is output in accordance with an instruction from the user. Specifically, an instruction from the user to the moving body 20 (a moving body different from the moving body 20 used at the time of generating the pre-trained model, or the same moving body as the moving body 20) through an input interface of a device owned by the user is transmitted from the device to the learning device 100, and is recognized by the first scene graph creation element 110 (FIG. 13/STEP 200). The environment image may be stored and held in the database 102, or may be directly transmitted from the device to the moving body assistance device 200.

The imaging device 22 mounted on the moving body 20 acquires the environment image (see FIG. 3) showing a designated place and a surrounding state acquired in a direction toward the location of the moving body 20 and the designated place (an imaging direction of the imaging device 22) (FIG. 13/STEP 202). The environment image may be stored and held in the database 102, or may be directly transmitted from the moving body 20 to the moving body assistance device 200.

The state scene graph SG1 (see FIG. 5) is created by the second scene graph creation element 210 on the basis of the location of the moving body 20 (at the time when the environment image is acquired), the environment image, and the three-dimensional high-definition map (FIG. 13/STEP 211). Subsequently, the layout scene graph SG2 (see FIG. 6) is created by convolving the state scene graphs SG1 by the second scene graph creation element 210 (FIG. 13/STEP 212). Further, the instruction scene graph SG3 (see FIG. 7) is created by convolving the layout scene graphs SG2 by the second scene graph creation element 210 (FIG. 13/STEP 213).

Next, the state scene graph SG1, the layout scene graph SG2, and the instruction scene graph SG3 are input to the pre-trained model generated on the basis of the graph neural network GNN (see FIG. 8) by the area candidate output element 220 (FIG. 13/STEP 220). Then, one area candidate is output as an output of the pre-trained model (FIG. 13/STEP 230). On the basis of the output result of the pre-trained model, the moving body control device 21 controls operations of the moving body 20 so that the designated state of the moving body 20 is realized in the one area candidate as the output result. The output result of the pre-trained model may be output to an output interface constituting the device.

### Effects

According to the learning device 100 that fulfils the above-described functions, the pre-trained model is built using, as the input data, the scene graphs SG1 to SG3 created based on the user's instruction and the environment image in the direction toward the location of the moving body 20 and the designated place (see FIG. 2).

The characteristic value of the primary node configuring the state scene graph SG1 is defined depending on the relative arrangement relationship (the distance and the angle) of each object with the location of the moving body 20 as a reference. Therefore, the characteristic values of the secondary nodes constituting the layout scene graph SG2 as the result of convolution of the state scene graph SG1 also reflect the relative arrangement relationships of the objects with the location of the moving body 20 as a reference. Further, the characteristic values of the tertiary nodes which constitute the instruction scene graph SG3 as the result of convolution of the layout scene graphs SG2 and indicate words contained in the instruction also reflect the relative arrangement relationships of the objects with the location of the moving body 20 as a reference.

As a result, even if any instruction of the user is vague space designation such as “right”, “front”, or “left”, the probability that an area (an example: a roadway grid cell) present in the space intended by the user is output as one area candidate is improved (see FIG. 13).

In addition, the characteristic values of the primary nodes constituting the state scene graph SG1 are defined depending on the space occupancy modes of the objects, specifically, the occupancy flag mainly representing the space occupancy states of the static objects and the interference flag mainly representing the space occupancy states of the dynamic objects. The same applies to the characteristic values of the secondary nodes constituting the layout scene graph SG2 and the characteristic values of the tertiary nodes constituting the instruction scene graph SG3.

This means that one appropriate area candidate for the moving body 20 to realize the designated state can be output from the pre-trained model by the moving body assistance device 200 while interference with the static objects and the dynamic objects is avoided.

For example, of the roadway grid cells X₂₁ to X₂₆ illustrated in FIG. 4, any one roadway grid cell X₂₁ or X₂₄ excluding the roadway grid cell X₂₂ corresponding to the crosswalk may be output, from the pre-trained model, as one area candidate for realizing the stop state (designated state) of the moving body 20 in response to the user's instruction of “please stop on the right side of X₀ (designated place)”. In addition, of the roadway grid cells X₂₁ to X₂₆ illustrated in FIG. 4, any one roadway grid cell X₂₁ or X₂₃ may be output, from the pre-trained model, as one area candidate for realizing the deceleration starting state (designated state) of the moving body 20 in response to the user's instruction of “please decelerate before X₀”. Further, of the roadway grid cells X₂₁ to X₂₆ illustrated in FIG. 4, any one roadway grid cell X₂₂ may be output, from the pre-trained model, as one area candidate for realizing the passing state (designated state) of the moving body 20 in response to the user's instruction of “please pass the left side of X₀”.

### Other Embodiments of Present Invention

According to the above-described embodiment, the environment image is acquired through the imaging device 22 mounted on the moving body 20. However, a virtual image acquired through a virtual imaging device mounted on the moving body 20 may be acquired as the environment image by using the three-dimensional high-definition map or the two-dimensional map (map information) on the basis of the measurement result of the location and the traveling direction of the moving body 20 on the global coordinate system or the map coordinate system.

### REFERENCE SIGNS LIST

20 Moving body
22 Imaging device
100 Learning device
102 Database
110 First scene graph creation element
120 Pre-trained model generation element
200 Moving body assistance device
210 Second scene graph creation element
220 Area candidate output element

1. A learning device that generates a pre-trained model trained on, as learning data,
an instruction to a target body related to realization of a designated state in a designated space around a designated place,
location information of the target body,
a plurality of scene graphs created based on an image around the designated place acquired based on a locational relationship between the target body and the designated place, and
a result of whether or not the designated state of the target body is realizable,
wherein the pre-trained model outputs one area candidate from a plurality of area candidates present in a plurality of surrounding spaces with the designated place as a reference.

2. The learning device according to claim 1, wherein
the plurality of scene graphs include:
a state scene graph created based on a location of the target body, the image, and map information and defined by a primary node representing each of a plurality of objects included in the image, an edge representing an adjacency relationship between the plurality of objects, and a characteristic value of the primary node depending on a relative arrangement relationship with the objects with the target body as a reference and a space occupancy state of the objects; and
a layout scene graph created by convolving the state scene graph and defined by a secondary node representing each of primary node clusters which includes one or a plurality of the primary nodes and corresponds to the designated place, a plurality of surrounding spaces with the designated place as a reference, area candidates in the plurality of surrounding spaces, and individual designated objects, an edge representing an adjacency relationship between object clusters including one or a plurality of the objects corresponding to the primary node cluster, and a characteristic value of the secondary node defined depending on a characteristic value of the primary node cluster.

3. The learning device according to claim 2, wherein
the plurality of scene graphs include an instruction scene graph created by convolving the layout scene graph and defined by a tertiary node representing a secondary node cluster which includes one or a plurality of the secondary nodes and corresponds to each of words related to the designated place, the designated space, and the designated state contained in the instruction, an edge representing an adjacency relationship between the words, and a characteristic value of the tertiary node determined depending on a characteristic value of the secondary node cluster.

4. The learning device according to claim 1, wherein
a weight propagates from above to below between nodes constituting an intermediate layer, and the pre-trained model is generated using a graph neural network defined to allow a weight to propagate from below to above.

5. The learning device according to claim 4, wherein
the pre-trained model is generated using the graph neural network defined to allow a weight to propagate from a node constituting one intermediate layer to a node constituting another intermediate layer present with one or a plurality of intermediate layers interposed between the one intermediate layer.

6. The learning device according to claim 1, wherein
the pre-trained model is generated, as the learning data, the plurality of scene graphs created based on an area present around the designated place and a result of whether or not the designated state of the target body is realizable in the area.

7. The learning device according to claim 1, wherein
the image is an image captured by an imaging device mounted on the target body.

8. The learning device according to claim 1, wherein
the designated state of the target body includes a stop state of the target body.
